(19) United States
(12) Patent Application Publication
(10) Pub. No.: US 2007/0087898 A1
(43) Pub. Date: Apr. 19, 2007

(54) Passive Start with invalid brake ON-OFF switch state

(75) Inventors: John R. Anderson, White Lake, MI (US); Kurt A. VanDrus, Macomb, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/446,744

(22) Filed: Jun. 5, 2006

Related U.S. Application Data
(60) Provisional application No. 60/728,005, filed on Oct. 18, 2005.

(51) Int. Cl. B60W 10/04

(52) U.S. Cl. 477/182

(57) ABSTRACT

A passive start system includes a brake system having a primary brake pedal switch associated with a brake pedal. The state of the primary brake pedal switch is monitored to achieve desired operation of the passive start system. The passive start system also includes a secondary brake pedal switch that is monitored to ensure that the state of the brake system is accurate, for example, if the primary brake pedal switch has malfunctioned. The passive start system monitors the primary brake pedal switch and/or the secondary brake system switch and starts the vehicle in response to a passive start signal when the brakes of the brake system are engaged.

The application claims priority to U.S. Provisional Application No. 60/728,005 which was filed on Oct. 18, 2005.

### BACKGROUND OF THE INVENTION

This invention relates to a system and method for passively starting a vehicle using a brake on-off switch state.

Passive start and entry systems are becoming increasingly more common in vehicles. Passive start systems provide keyless access to the vehicle and the ability to start the vehicle's engine without using a key. Drivers carry an identification device to gain access to the vehicle by touching the door handle, in one example. Once the driver is inside the vehicle, the engine can be started by simply pressing a start button.

In one type of system, the vehicle can only be started passively with the brake pedal pressed so that the brake system is engaged, as is commonly found in more traditional keyed ignition systems. If the brake pedal is not depressed, then pressing the start button will be ignored and the ignition may be switched to an ACCESSORY or RUN mode.

If the brake on-off switch associated with the brake pedal malfunctions, then the engine may unexpectedly start if the start button is pressed. Alternatively the engine may not start and the driver may be left stranded. Specifically, brake on-off switches that malfunction so that they are in the permanently ON state will start the engine unexpectedly if someone presses the start button. Conversely, when the brake on-off switch malfunctions so that it is in the OFF state permanently, the driver will be unable to start the vehicle engine.

What is needed is a brake system and method that enables proper use of the passive start system when the brake pedal switch has malfunctioned.

### SUMMARY OF THE INVENTION AND ADVANTAGES

A passive start system includes a brake system having a primary brake pedal switch associated with a brake pedal. The state of the primary brake pedal switch is monitored to achieve desired operation of the passive start system. The passive start system also includes a secondary brake pedal switch that is monitored to ensure that the state of the brake system is accurate, for example, if the primary brake pedal switch has malfunctioned. The passive start system monitors the primary brake pedal switch and/or the secondary brake system switch and starts the vehicle in response to a passive start signal when the brakes of the brake system are engaged.

These and other features of the present invention can be best understood from the following specification and drawings, the following of which is a brief description.

### BRIEF DESCRIPTION OF THE DRAWINGS

FIG. 1 is a schematic view of a passive start system with an example brake system.

FIG. 2 is a flow chart illustrating an example method employed by the example passive start system shown in FIG. 1.

### DETAILED DESCRIPTION OF THE PREFERRED EMBODIMENT

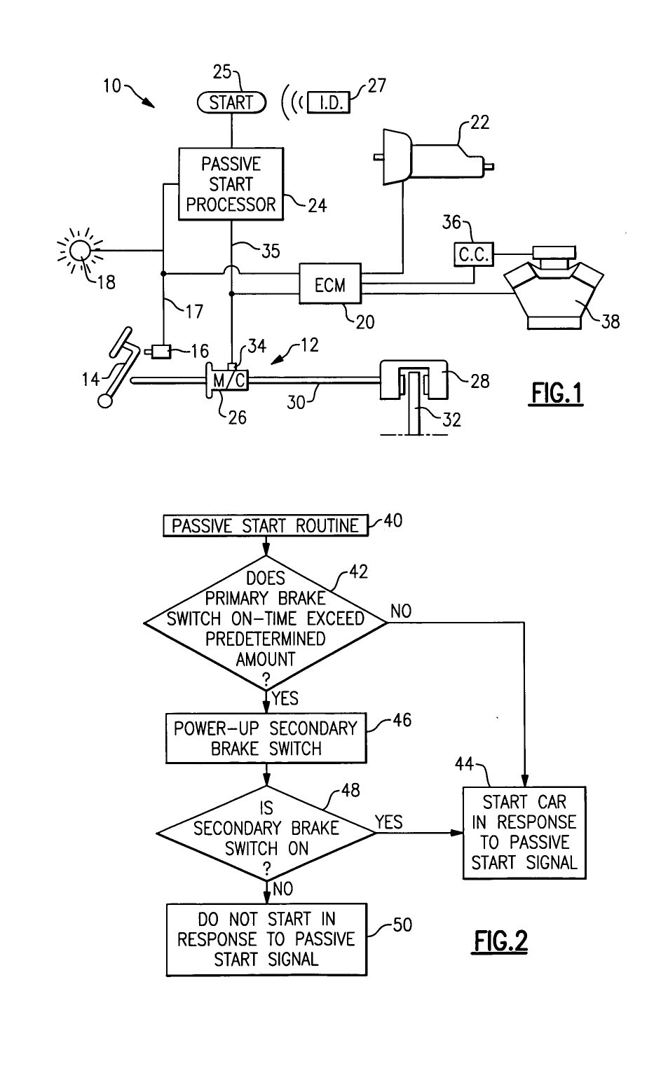

An example passive start system 10 is shown in FIG. 1. The passive start system 10 includes a brake system 12 that is monitored by the passive start system 10 using a passive start processor 24. Typically, the passive start system 10 will only permit the vehicle's engine 38 to be started by the passive start button or switch 25 when the brakes 28 of the brake system 12 are engaged, for example, when a driver ID 27 is within a desired range of the passive start system 10.

The brake system 12 includes a brake pedal 14 that has a brake pedal switch 16 for detecting movement of the brake pedal 14. The brake pedal switch 16 will produce a brake-ON signal 17 when the brake pedal 14 is depressed to engage the brakes 28. Typically, tail lights 18 are illuminated when the brake pedal switch 16 is ON.

The vehicle typically includes one or more control modules, such as an engine control module 20 (ECM). The ECM 20 may be a separate processor or integrated with other processors within the vehicle. The ECM 20 communicates with various components of the vehicle, directly or indirectly such as a transmission 22, the engine 38 and a cruise control module 36.

The brake system 12 includes a master cylinder 26 that is actuated by the brake pedal 14 and provides pressurized hydraulic fluid through a fluid line 30 to the brakes 28 to engage a brake rotor 32, for example. The master cylinder 26 may include a brake pressure switch 34 for monitoring the pressure of hydraulic fluid within the brake system 12. The brake pressure switch 34 produces a secondary brake signal 35 indicative of the brake 28 being engaged. The secondary brake signal 35 may also be used by the ECM 20 to control the cruise control module 36, for example.

The passive start system 10 uses the secondary brake signal 35 from the brake pressure switch 34 so that a malfunctioning brake pedal switch 16 will not cause improper operation of the passive start system 10. Referring to FIG. 2, a passive start routine 40 is illustrated. In the example embodiment, the brake pedal switch 16 is used by the passive start processor 24 as the primary brake signal source. In one example, the ON-time of the brake pedal switch 16 is monitored (block 42) to determine if the ON-time exceeds a predetermined duration. For example, the brake pedal switch 16 producing a brake-ON signal 17 lasting several minutes is likely indicative of a malfunctioning brake pedal switch 16. If the brake pedal switch 16 ON-time does not exceed a predetermined amount then the normal passive start procedure may be used and the car may be started in response to a passive start signal, as indicated at block 44. However, if the brake-ON signal 17 exceeds a predetermined amount of time then the brake pressure switch 34 is referenced. Information is obtained from the brake pressure switch 34 either directly or from a bias message ECM 20, for example. The ECM 20 and/or brake pressure switch is powered (block 46), if necessary, to obtain a signal indicative of the state of the brake system 12. Typically, the brake pressure switch 34 only generates signals when the ignition is in an ACCESSORY or RUN mode.

If the secondary brake signal 35 is indicative of the brake system 12 being engaged (block 48), then the normal passive start procedure may be used, as indicated at block 44. The brake system 12 being engage corresponds to the hydraulic pressure reaching a predetermined pressure. However, if the secondary brake signal is not indicative of the brake system 12 being in an engaged state, then the vehicle's engine is not started in response to a passive start signal (block 50). In this manner, a secondary brake signal is used to ensure that the passive start system 10 has accurate information relating to the state of the brake system 12 to prevent undesired operation of the passive start system 10.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A passive start system for a vehicle engine comprising:
a brake system including primary and secondary brake switches; and
a processor monitoring the primary and secondary brake switches to produce a passive start signal in response to a valid brake-ON condition from at least one of the primary and secondary brake switches.

2. The system according to claim 1, wherein the brake system includes a brake pedal and the valid brake-ON condition is produced in response to depressing the brake pedal.

3. The system according to claim 1, wherein the brake system includes a hydraulic pressure, the valid brake-ON condition is produced in response to the hydraulic pressure reaching a predetermined pressure.

4. The system according to claim 3; comprising a cruise control module operable in response to a signal from the secondary brake switch.

5. The system according to claim 1, comprising a passive start switch communicating with the processor, and an engine, the processor starting the engine in response to the passive start signal produced by the passive start switch.

6. A method of passively starting a vehicle engine comprising the steps of:
a) monitoring a duration of a primary brake switch ON signal;
b) referencing a secondary brake switch condition if the primary brake switch ON signal exceeds a predetermined time; and
c) starting a vehicle engine in response to a brake-ON signal from at least one of the primary and secondary brake switches.

7. The method according to claim 6, wherein step a) includes detecting a position of a brake pedal with the primary brake switch.

8. The method according to claim 6, wherein step b) includes detecting a hydraulic pressure with the secondary brake switch.

9. The method according to claim 6, wherein step b) includes powering the secondary brake switch.

10. The method according to claim 6, wherein step c) includes actuating a passive start switch.

11. A method of passively starting a vehicle engine comprising the step of:
starting a vehicle engine in response to a brake-ON signal from a hydraulic pressure brake switch within a brake system.
